(19) United States
(12) Patent Application Publication
(10) Pub. No.: US 2013/0322889 A1
(43) Pub. Date: Dec. 5, 2013

(54) ROTARY TRANSMISSION DEVICE FOR MACHINE TOOLS

(71) Applicant: Heiko Graf, Woerth am Rhein (DE)

(72) Inventor: Heiko Graf, Woerth am Rhein (DE)

(21) Appl. No.: 13/984,926

(22) PCT Filed: Feb. 29, 2012
(86) PCT No.: PCT/EP2012/053459

§ 371 Date: Aug. 12, 2013

(30) Foreign Application Priority Data
Mar. 10, 2011 (DE) 10 2011 005 339.5

(51) Int. Cl. H04B 10/80

(52) U.S. Cl. CPC H04B 10/80
USPC 398/141

(57) ABSTRACT

The invention relates to a rotary transmission device for machine tools, comprising a stator part that is rigidly attached to the machine, a rotor part that is rigidly attached to the tool and can be rotated about a rotational axis, and stator-side and rotor-side transmitting and receiving elements for bidirectionally transferring data without contact. According to the invention, in order to guarantee trouble-free data transfer even for inductive energy transmission at high power, the transmitting and receiving elements are designed as optoelectronic components, which are combined on the stator part and the rotor part to form stator-side and rotor-side transmitter groups and receiver groups each having associated transmitting and receiving electronics. The transmitting and receiving elements of the rotor-side and stator-side transmitter and receiver groups associated with each other face each other in pairs by means of an axial light-guiding segment and are arranged relative to each other in such a way that the transmitter and receiver groups associated with each other communicate with each other by means of at least one of the transmitting and receiving elements thereof in each rotational position of the rotor part relative to the stator part.

The invention relates to a rotary transmission device for machine tools having a stator part which is fixed to the machine, a rotor part which is fixed to the tool and can be rotated about a rotation axis, and having stator- and rotor-side transmitting and receiving elements for bidirectional data transmission without contact.

Rotary transmission devices of this kind are used, for example, in machine tools having adjustment tools (EP 1 856 705 B1). In the rotary transmission device already known, the stator- and rotor-side transmitting and receiving elements have stator- and rotor-side coupling turns, which are associated with one another in pairs, for inductive data transmission, said coupling turns being connected to a transmitting and receiving electronics system. Furthermore, a stator-side and a rotor-side power winding, which is concentric to the coupling turns, is provided in each case for inductive power transmission in accordance with the transformer principle. The power windings and the coupling turns are separated from one another by in each case a stator-side and a rotor-side core part, wherein the stator-side and the rotor-side core parts are separated from one another at mutually facing ends by means of an air gap. A particular disadvantage of this known arrangement is that, in spite of the ferromagnetic core parts arranged between the transmission sections for data and power transmission, considerable interference in data transmission is caused by power transmission. This means that the transmission rate by means of the power windings is subject to limits which restrict the range of application.

Proceeding from this, the invention is based on the object of developing a rotary transmission system which is less susceptible to faults at high power transmission rates.

The features indicated in patent claim 1 are proposed for achieving this object. Advantageous refinements and developments of the invention can be found in the dependent claims.

The solution according to the invention substantially involves the transmitting and receiving elements being in the form of optoelectronic components which are combined on the rotor part and the stator part to form rotor-side and stator-side transmitter groups and receiver groups which each have an associated transmitting and receiving electronics system. It has proven particularly advantageous in this case when the transmitting and receiving elements of the associated rotor-side and stator-side transmitter and receiver groups face one another in pairs across an axial transmission section and are arranged relative to one another such that, in each rotation position of the rotor part with respect to the stator part, the associated transmitter and receiver groups communicate with one another by means of at least one of their respective transmitting and receiving elements. This ensures data communication remains uninterrupted when the rotor part is rotating and when it is stationary.

According to one advantageous refinement of the invention, the transmitting and receiving elements of the associated transmitter and receiver groups are arranged on a stator-side and a rotor-side circle or segment of a circle at an approximately identical radius with respect to the rotation axis. This can be performed, for example, by the transmitting and receiving elements of the associated transmitter and receiver groups being arranged in pairs on identical radii. It is particularly advantageous when all the transmitting and receiving elements are arranged on the same radius.

A further advantageous refinement of the invention makes provision for the transmitting and receiving elements of the transmitter and receiver groups to be arranged at defined angular distances from one another on the rotor part and the stator part.

A preferred refinement of the invention makes provision for in each case a stator-side and a rotor-side power winding to be provided for inductive power transmission in accordance with the transformer principle, said power windings being concentric to the adjacent transmitter and receiver group with respect to the rotation axis. In this case, the power windings are wound on a respective stator-side and a rotor-side core part, said core parts being composed of ferromagnetic material and being separated from one another at mutually facing ends by means of an air gap.

In order to allow access to the rotor by an automatic handling system, it is advantageous when the stator part extends only over a cylindrical segment by way of its transmitter and receiver groups and by way of its power winding, whereas the rotor part can extend over a full cylinder by way of its transmitter and receiver groups and its power winding. A variant embodiment with a full-cylinder stator part is also feasible in principle.

A further advantageous refinement of the invention makes provision for the transmitting elements to be in the form of light-emitting diodes (LED), whereas the receiving elements can be in the form of photodiodes or photo elements. The transmitting elements and the receiving elements advantageously form a physical unit and can be selectively switched over for half-duplex operation.

In order to avoid interference in the transmitting and receiving elements and the electronics systems thereof by stray electromagnetic fields from the inductive power transmission section, provision is made, according to a preferred refinement of the invention, for the rotor-side and the stator-side transmitting and receiving elements, together with their transmitting and receiving electronics systems, to be arranged axially offset with respect to the air gap and to be connected to an inlet or outlet window, which is transparent in the direction of the air gap, by means of a light guide section.

A further improvement in this respect is achieved by the transmitting and receiving elements, together with their transmitting and receiving electronics systems, being arranged in a housing, which is shielded from the power transmission section, of the rotor or stator. In this case, the light guide section can be formed by a transparent intermediate layer. As an alternative to this, the light guide section can comprise a light guide, a bundle of light guides or a light-scattering diffuser. Furthermore, for optimum accommodation of connecting cables and better utilization of space, it may be advantageous when a mirror or a prism for deflecting a light beam which is modulated with the data which is to be transmitted is arranged in the light guide section, in particular, of the stator.

The invention will be explained in greater detail below with reference to the exemplary embodiments which are schematically illustrated in the drawing, in which

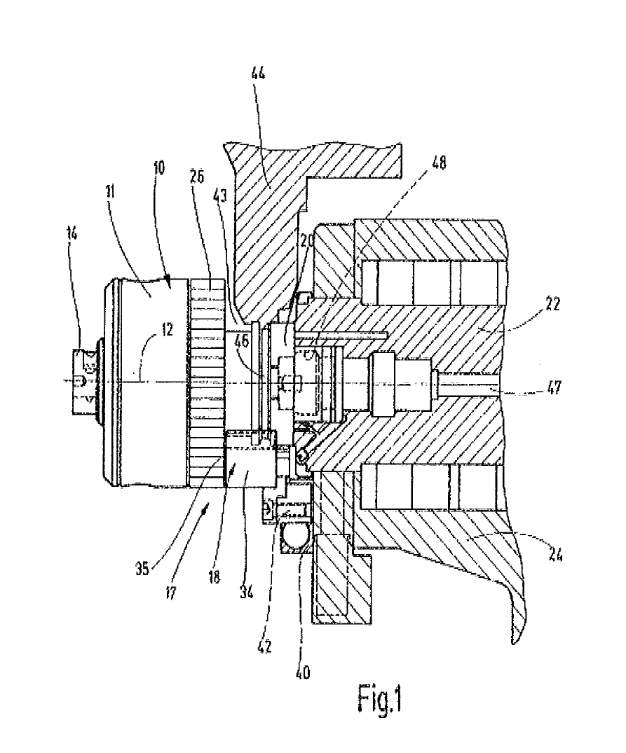

FIG. 1 shows a partially sectioned side view of a tool head, which is clamped in a machine spindle, with a rotary transmission device for power and data transmission;

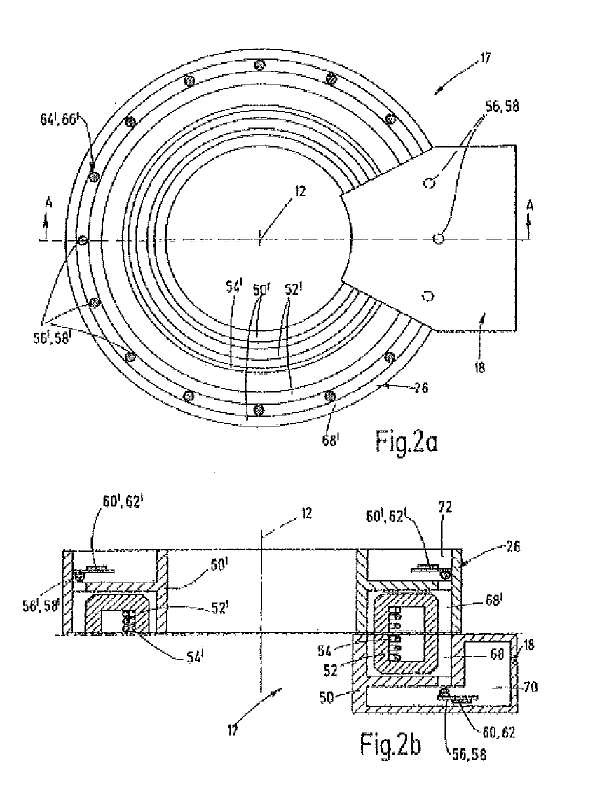

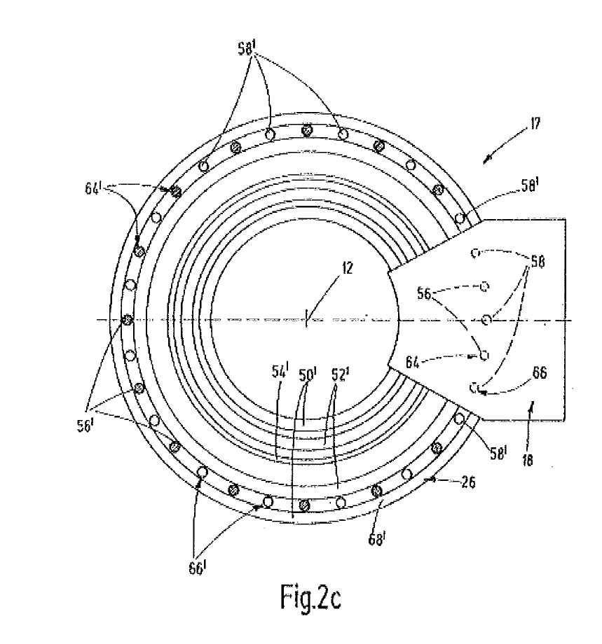

FIG. 2a shows a plan view of the rotary transmission device, as seen from the stator side, for data transmission with half-duplex operation;

FIG. 2b shows a section along section line A-A of FIG. 2a;

FIG. 2c shows an illustration in line with FIG. 2a for data transmission with full-duplex operation;

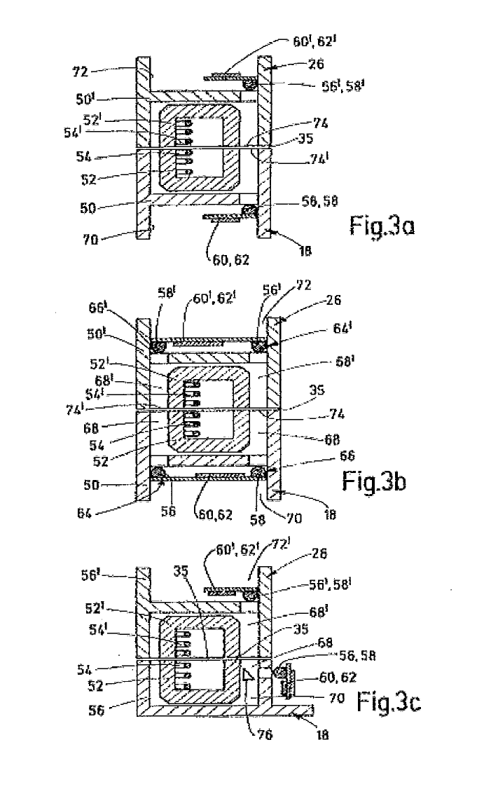

FIGS. 3a to c show an illustration of a detail in line with FIG. 2b of a section through the data transmission device for three different variant embodiments.

The tool head 10, which is illustrated in FIG. 1 and is in the form of a precision turning head, substantially comprises a main body 11, a slide 14 which can be moved transverse to the rotation axis 12 of the tool head 10 with respect to the main body 11 and has a cutting tool, at least one electrical load (not illustrated) which is arranged within the tool head 10, for example in the form of a measuring device for direct adjustment movement measurement, and an electric adjusting motor for the slide 14. The electrical power supply for the electrical loads and the data interchange are provided via a rotary transmission device 17 which comprises a stator part 18 and a rotor part 26. The tool head 10 can be coupled to the machine spindle 22 of a machine tool 24 by way of a tool shank 20 which projects axially beyond the main body 11. In order to adjust an air gap 35 between the stator part and the rotor part, the stator housing 34 is arranged on a holder 40, which is fixed to the stator, by means of an adjustment mechanism 42 such that both its distance from the rotor and its rotary position about an axis parallel to the rotation axis 12 can be adjusted.

In the exemplary embodiment shown in FIGS. 1 and 2a and b, the stator part 18 extends in the manner of a segment only over a portion of the circumference of approximately 60° to 70° of the tool shank 20 and leaves the majority of the shank circumference free, so as to form a free space 43 for access of a tool gripper 44 for automatic tool changing. When the tool is changed, the tool head 10 is grasped at the gripper groove 46 by the tool gripper 44 from the side opposite the stator part, and is moved axially with respect to the machine spindle 22 when the tool coupling is released. The tool head 10 is coupled to the machine spindle 22 via a clamping mechanism which can be operated on the machine side via the tie rod 47, engages from the machine side in the cavity 48 in the tool shank 20, and couples the tool head to the machine spindle 22 so as to provide planar surface clamping and radial clamping.

Power is transmitted between the stator part 18 and rotor part 26 without contact in accordance with the transformer principle. For this purpose, the stator part 18 and the rotor part 26 each have a core part 52, 52′ which is composed of ferromagnetic material and is arranged in a housing 50, 50′ and also in each case a power winding 54, 54′ which is wound onto the stator-side and the rotor-side core part 52, 52′. In FIGS. 2a, b and c and also 3a, b and c, the power windings 54, 54′ and the core parts 52, 52′ are schematically illustrated as ring elements which are arranged concentrically with respect to the rotation axis 12.

The transmitting and receiving elements 56, 58′; 56′, 58 for data transmission are in the form of optoelectronic components. The transmitting elements 56, 56′ are light-emitting diodes (LED) and the receiving elements 58, 58′ are photodiodes or optoelectronic photo elements. The transmitting elements 56, 56′ have an associated transmitting electronics system 60, 60′ and the receiving elements 58, 58′ have an associated receiving electronics system 62, 62′. The transmitting elements 56, 56′ and the receiving elements 58, 58′ are both combined on the stator side and on the rotor side to form transmitter groups 64, 64′ and to form receiver groups 66, 66′. In this case, the associated rotor-side and stator-side transmitter and receiver groups 64, 66′; 64′, 66 face one another in pairs across an axial light guide section 68, 68′ and are arranged relative to one another in circles which are concentric with respect to the rotation axis 12 (FIG. 2a) such that, in each rotation position of the rotor part 26 in relation to the stator part 18, the associated transmitter and receiver groups 64, 66′; 64′, 66 communicate with one another by means of at least one of their respective transmitting and receiving elements 56, 58′; 56′, 58.

In the exemplary embodiments shown in FIGS. 2a, 3a and 3 c, the transmitting and receiving elements 56, 58; 56′, 58′ are combined in one component. In order to allow for bidirectional data transmission, the transmitting and receiving elements 56, 58′; 56′, 58 which are combined in groups are operated as transmitters and as receivers alternately by means of their transmitting and receiving electronics systems 60, 62′; 60′, 62 using half-duplex operation. The changeover is made in a centrally controlled manner such that data is alternately transmitted from the stator part 18 to the rotor part 26 and from the rotor part 26 to the stator part 18.

In an arrangement according to FIG. 2c, it is also possible to operate the transmitter groups 64, 64′ and receiver groups 66, 66′ which are each arranged on the same diameter of the circle using the full-duplex method when the transmitting elements 56, 56′ and receiving elements 58, 58′ which are associated with one another and have different directions emit and receive different colored light (for example 56, 58′ red, and 56′, 58 green) and as a result do not interfere in the respectively other group.

In the exemplary embodiment shown in FIG. 3b, a transmitter group 64, 64′ and a receiver group 66, 66′ are each provided on the stator part 18 and on the rotor part 26, said transmitter and receiver groups being arranged on different radii of the stator part 18 and of the rotor part 26. With this arrangement, bidirectional data transmission using the full-duplex method is also possible with identical carrier light colors. The transmitter and receiver groups 64, 66′; 64′, 66 which face one another in the rotor part 26 and in the stator part 18 communicate in opposite directions from the stator part 18 to the rotor part 26 and from the rotor part 26 to the stator part 18.

As shown in FIGS. 2a and 3a to c, the transmitting and receiving elements 56, 56′, 58, 58′ both in the stator part 18 and in the rotor part 26 are arranged in their own housing section 70, 72 in a manner axially offset with respect to the air gap 35. Optical coupling between the transmitting and receiving elements 56, 58′; 56′, 58 is performed by means of light guide sections 68, 68′ and inlet and outlet windows 74, 74′ in the light guide sections 68, 68′ which face one another across the air gap 35. The axial offset of the optoelectronic transmitting and receiving elements 56, 56′, 58, 58′ and the associated transmitting and receiving electronics systems 60, 60′, 62, 62′ ensures that sufficient shielding from electromagnetic scatter radiation from the power transmission section and therefore also interference-free data interchange, even at high transmission rates in respect of power, are possible. The light guide section 68, 68′ can be formed, for example, by a transparent intermediate layer. Light guides or bundles of light guides can also be used for this purpose in principle. In order to propagate the transmission of light, the light guide section can also be in the form of a diffuser which guides light.

A special feature of the exemplary embodiment shown in FIG. 3c is that a mirror or a prism 76 for deflecting a light beam which is used for data transmission is arranged in the light guide section 68 on the stator side 18. By way of this measure, it is possible to keep the axial extent of the stator housing 34, and therefore the interfering contour thereof, small.

In principle, it is possible to use a two-part housing 34 for the stator part 18, said two-part housing being made up of a main housing and an interchangeable housing. In this case, the main housing can be fixed to the holder 40 which is fixed to the stator, while the interchangeable housing can be fastened to the main housing in a detachable manner at a disconnection point (not illustrated). In the main housing, the transmitting and receiving electronics systems 60, 62 and the signal-conditioning electronics system and the electrics for power supply can be arranged on a printed circuit board which can be connected to the machine control system by means of a cable which passes through an opening in the main housing. The power winding 54, 54′ is embedded in a potting compound which is composed of synthetic resin with a wear-resistant additive, such as ceramic, stone dust, glass fibers, and is located in the interchangeable housing behind a housing window. The light guide section 68, 68′ can also be composed of a synthetic resin with a wear-resistant additive. In order to protect the stator windings 54 against unnecessary wear, the interchangeable housing, primarily when tools of conventional design which do not have a rotor part 26 which engages over the stator part 18 are used, can be removed by simple manual actions, without the main housing having to be removed. An additional way of protecting against wear involves the housing window of the stator part 18 being closed by a cover (not illustrated) when not in use. The process of fitting and removing the cover can be automated.

In summary, the following can be stated: the invention relates to a rotary transmission device 17 for machine tools having a stator part 18 which is fixed to the machine, a rotor part 26 which is fixed to the tool and can be rotated about a rotation axis 12, and having stator- and rotor-side transmitting and receiving elements 56, 58′; 56′, 58 for bidirectional data transmission without contact. In order to ensure interference-free data transmission even in the case of inductive power transmission at a high rate, the invention proposes forming the transmitting and receiving elements 56, 56′, 58, 58′ in the form of optoelectronic components which are combined on the stator part 18 and the rotor part 26 to form stator-side and to form rotor-side transmitter groups 64, 64′ and receiver groups 66, 66′ which each have an associated transmitting and receiving electronics system 60, 62, 60′, 62′. The transmitting and receiving elements 56, 58′; 56′, 58 of the associated rotor-side and stator-side transmitter and receiver groups 64, 66′; 64′, 66 face one another in pairs across an axial light guide section 68, 68′ and are arranged relative to one another such that, in each rotation position of the rotor part 26 with respect to the stator part 18, the associated transmitter and receiver groups 64, 66′; 64′, 66 communicate with one another by means of at least one of their transmitting and receiving elements 56, 58′; 56′, 58.

### LIST OF REFERENCE SYMBOLS

10 Tool head
11 Main body
12 Rotation axis
14 Slide
17 Rotary transmission device
18 Stator part
20 Tool shank
22 Machine spindle
24 Machine tool
26 Rotor part
34 Stator housing
35 Air gap
40 Holder
42 Adjustment mechanism
43 Free space
44 Tool gripper
46 Gripper groove
47 Tie rod
48 Cavity
50, 50′ Housing
52, 52′ Core part
54, 54′ Power winding
56, 56′ Transmitting elements
58, 58′ Receiving elements
60, 60′ Transmitting electronics system
62, 62′ Receiving electronics system
64, 64′ Transmitter groups
66, 66′ Receiver groups
68, 68′ Light guide section
70, 72 Housing section
74, 74′ Inlet and outlet windows
76 Prism or mirror

1-16. (canceled)

17. A rotary transmission device for machine tools having a stator part (18) which is fixed to the machine, a rotor part (26) which is fixed to the tool and can be rotated about a rotation axis (12), and having stator- and rotor-side transmitting and receiving elements (56, 56′, 58, 58′) for bidirectional data transmission without contact, wherein the transmitting and receiving elements (56, 56′, 58, 58′) are in the form of optoelectronic components which are combined on the stator part (18) and the rotor part (26) to form stator-side and rotor-side transmitter groups (64, 64′) and receiver groups (66, 66′) which each have an associated transmitting and receiving electronics system (60, 60′, 62, 62′), wherein the transmitting and receiving elements (56, 58′; 56′, 58) face one another in pairs and are arranged relative to one another such that, in each rotation position of the rotor part (26) with respect to the stator part (18), the associated transmitter and receiver groups (64, 66′; 64′, 66) communicate with one another by means of at least one of their respective transmitting and receiving elements (56, 58′; 56′, 58), and wherein in each case a stator-side and a rotor-side power winding (54, 54′) is provided for inductive power transmission in accordance with the transformer principle, said power windings being separated from one another by an air gap (35), characterized in that the stator-side and the rotor-side power windings face one another across an axial air gap (35) and are arranged concentrically to the respectively adjacent transmitter and receiver group (64, 66′, 64′, 66) with respect to the rotation axis, and in that the stator-side and the rotor-side transmitting and receiving elements (56, 56′, 58, 58′), together with their transmitting and receiving electronics systems (60, 60′, 62, 62′), are arranged axially offset with respect to the air gap (35) in a housing (50, 50′), which is shielded from the power windings (54, 54′), of the stator part (18) or rotor part (26) and are optically coupled to an inlet or outlet window (74, 74′), which is transparent in the direction of the air gap (35), by means of in each case one axial light guide section (68, 68′).

18. The rotary transmission device as claimed in claim 17, characterized in that the transmitting and receiving elements (56, 58′; 56′, 58) of the associated transmitter and receiver groups (64, 66′; 64′, 66) are arranged on a stator-side and a rotor-side circle or segment of a circle with an approximately identical radius with respect to the rotation axis (12).

19. The rotary transmission device as claimed in claim 17, characterized in that the transmitting and receiving elements (56, 58′; 56′, 58) of the associated transmitter and receiver groups (64, 66′; 64′, 66) are arranged in pairs on identical radii.

20. The rotary transmission device as claimed in claim 17, characterized in that all the transmitting and receiving elements (56, 56′, 58, 58′) are arranged on the same radius.

21. The rotary transmission device as claimed in claim 20, characterized in that the transmitting and receiving elements (56, 58′; 56′, 58) of the associated transmitter and receiver groups (64, 66′; 64′, 66) which have different directions emit and receive different colored light.

22. The rotary transmission device as claimed in claim 17, characterized in that the transmitting and receiving elements (56, 56′, 58, 58′) of the transmitter and receiver groups (64, 64′, 66, 66′) are arranged at defined angular distances from one another on the stator part (18) and the rotor part (26).

23. The rotary transmission device as claimed in claim 17, characterized in that the stator part (18) extends over a cylindrical segment by way of its transmitter and receiver groups (64, 66) and by way of its power winding (54).

24. The rotary transmission device as claimed in claim 17, characterized in that the rotor part (26) extends over a full cylinder by way of its transmitter and receiver groups (64′, 66′) and its power winding (54′).

25. The rotary transmission device as claimed in claim 17, characterized in that the transmitting elements (56, 56′) are in the form of light-emitting diodes (LED).

26. The rotary transmission device as claimed in claim 17, characterized in that the receiving elements (58, 58′) are in the form of photo elements or photodiodes.

27. The rotary transmission device as claimed in claim 17, characterized in that the light guide section (68, 68′) is formed by a transparent intermediate layer.

28. The rotary transmission device as claimed in claim 27, characterized in that the light guide section (68, 68′) comprises a light guide or a bundle of light guides.

29. The rotary transmission device as claimed in claim 27, characterized in that the light guide section (68, 68′) comprises a diffuser which guides light.

30. The rotary transmission device as claimed in claim 27, characterized in that a mirror or a prism (76) for deflecting a light beam which is used for data transmission is arranged in the light guide section (68, 68′).

31. The rotary transmission device as claimed in claim 30, characterized in that the transmitting and receiving elements (56, 58′; 56′, 58) of the associated transmitter and receiver groups (64, 66′; 64′, 66) are arranged on a respective stator-side and a rotor-side circle or segment of a circle with radii, which differ in pairs, with respect to the rotation axis (12).
